(19) United States
(12) Patent Application Publication
(10) Pub. No.: US 2006/0151448 A1
(43) Pub. Date: Jul. 13, 2006

(54) Torch height control apparatus with a gear belt drive, altering wheelbase of the wheel axis and solid body, attached to the gear belt

(76) Inventor: Jaan Abram, Tallinn (EE)

Correspondence Address: JAAN ABRAM, VALGUSE 11B, TALLINN, 11616, EE

(21) Appl. No.: 11/320,461

(22) Filed: Dec. 28, 2005

(30) Foreign Application Priority Data
Sep. 23, 2004 (EE) 0111/04 PV

(51) Int. Cl. B23K 9/00; B23K 9/02

(52) U.S. Cl. 219/121.56

(57) ABSTRACT

A torch height control apparatus with a synchronous belt drive, altering wheelbase of the wheel axis and solid body, attached to the gear belt on various mechanized shape cutting machines is provided for positioning the tip of a torch with respect to a workpiece to a predetermined height at the beginning of the cutting process, commonly known as pierce height. The system is also responsive to the torch tip collisions with the workpiece during the cutting process commonly known as vertical collision control. The system also fills the role of the upper and lower limit switch.

### TECHNICAL FIELD

The present invention pertains to a torch height control apparatus of different shape cutting machines where initial height sensing and non-contact positioning of the tip of a cutting torch with respect to a workpiece is needed.

### BACKGROUND OF THE INVENTION

By mechanized shape cutting of metal, with using oxy-fuel, plasma or laser torches, positioning of the torch with respect to a workpiece is needed. To perform an optimal cutting operation, the torch must be positioned at a predetermined non-contact height above the workpiece.

It is also important to “sense” the location of the workpiece surface with the torch tip at the beginning of the cutting process. This is commonly known as initial height sensing for establishing the torch pierce distance. In one such prior art system, the increased load on the motor, used to drive the torch lift station, is detected as the torch tip is driven downwardly into contact with the plate or other workpiece. A control system responsive to the increase in drive motor current stops the motor, and reverses it to raise the torch to the predetermined initial operative height. Absence of encoder velocity is also used for the same purpose.

A lot of other methods of initial height sensing exist, which can be used as a supporting height sensing mechanism—like utilizing a circuit ground signal as the tip of the torch contacts the plate, commonly know as an ohmic sensor, also to stop and reverse the vertical torch transport mechanism. Capacitive, inductive, optical and acceleration sensors are also useful. But with each of these types of sensors, the point on the plate directly under the torch tip is not detected and as a result an error in initial height may result.

With stepper motor solutions there is no feedback in motor drive wires, because the pulsing electrical current that passes through the windings does not change when the motor stalls. Other indicia of a stalled stepper motors is the same as of running motors. On the other hand, a stepper motor is well suitable for torch height control applications like this, while motor torque is inversely proportional to rotating velocity, witch possible small fast linear movements, needed by making fast adjustments of torch height during cutting process. The utilization of stepper motors also requires smaller transmission ratio from the gear. Small transmission ratio can be easily realized, for example, with a gear belt. The gear belt is also well suitable because of its dustproofness; usually a lot of dust arises during the cutting process.

On the bottom line, it is a good idea to use a stepper motor with a gear belt drive to control the height of the torch for its powerfulness, simplicity and reasonable price.

### SUMMARY OF INVENTION

The present invention, a torch height control system is provided, which is operable both to provide initial height sensing and torch retraction as result of collision.

The linear height positioning mechanism of the workstation works with a gear belt drive. The upper drawing pulley is attached straight to the axis of the stepper motor. A freely rotating lower pulley is attached to a machine body with a turning switch lever which enables by strength, created by the belt, to change position on the axis of a freely moving pulley. By turning the switch lever, the switch is enabled. A control system responsive to the switch stops the motor and reverses it to raise the torch to the predetermined initial operative height. That kind of a construction works also as an end switch in case there is no workpiece under a torch tip.

The fact that the switch described above also fills the function of the end switch at the upper end is an important character. A solid body is attached to the belt, for example a rubber O-ring, which moves along with the belt. As the vertical torch transport mechanism moves up, the solid body gets between the gear belt and the pulley, stretching the gear belt so that the axis of the lower freely spinning pulley shifts and the switch applies. The position of the upper end can be easily altered, moving the O-ring on the gear belt.

### BRIEF DESCRIPTION OF THE DRAWINGS

FIG. 1 is a front view of the torch lifter, scale 1:3

FIG. 2 is a side view of the torch lifter, scale 1:3

FIG. 3 is the top view of the torch lifter, scale 1:3

FIG. 4 is the cut along line A-A of the torch lifter, scale 1:3

FIG. 5 is the cut along line B-B of the torch lifter, view from the back on the switch mechanism, where the switch is not enabled, scale 1:3

FIG. 6 is the cut along line B-B of the torch lifter, view from the back on the switch mechanism, where the switch is enabled, scale 1:3

FIG. 7 is the cut along the line C-C that passes through the surface of the switch lever axis and the freely rotating pulley axis, scale 1:1

FIG. 8 is a schema of the device in the case where the solid body attached to the gear belt has moved in between the belt and the upper pulley, the switch is enabled and fulfils the function of the upper limit switch

FIG. 9 is a schema of the device in the case where the torch tip is in contact with workpiece resulting from vertical downward movement or vertical collision during cutting process, cause movement of freely rotating wheel axle, the switch is enabled and fills the function of the initial height sensing

FIG. 10 is a schema of the device during the cutting process; the switch is not enabled and not involved in the work of the torch height control system

FIG. 11 is a schema of the device in the case where there is no material to cut or it is too far; the switch is enabled and fills the function of the lower limit switch.

### DETAILED DESCRIPTION OF THE INVENTION

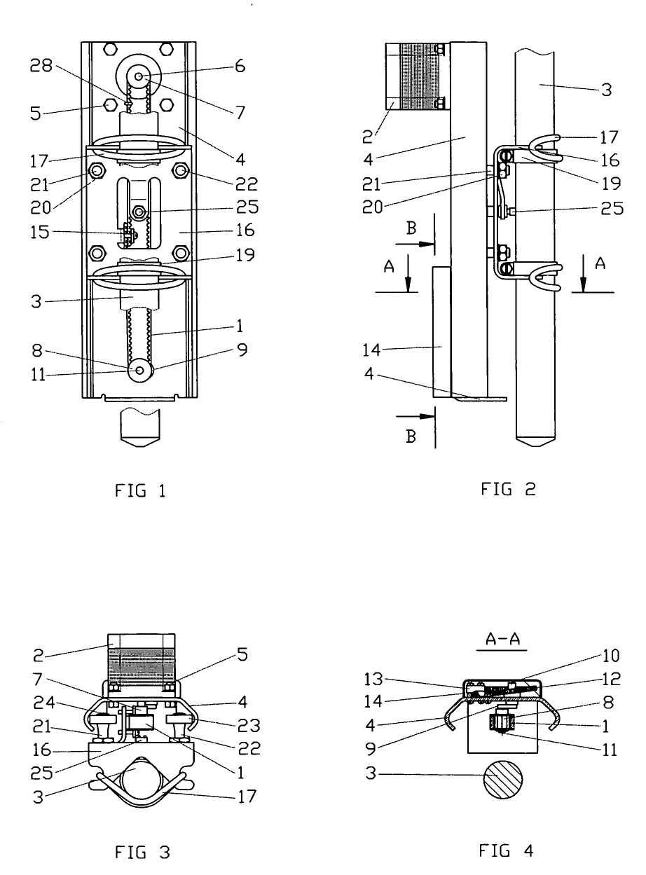

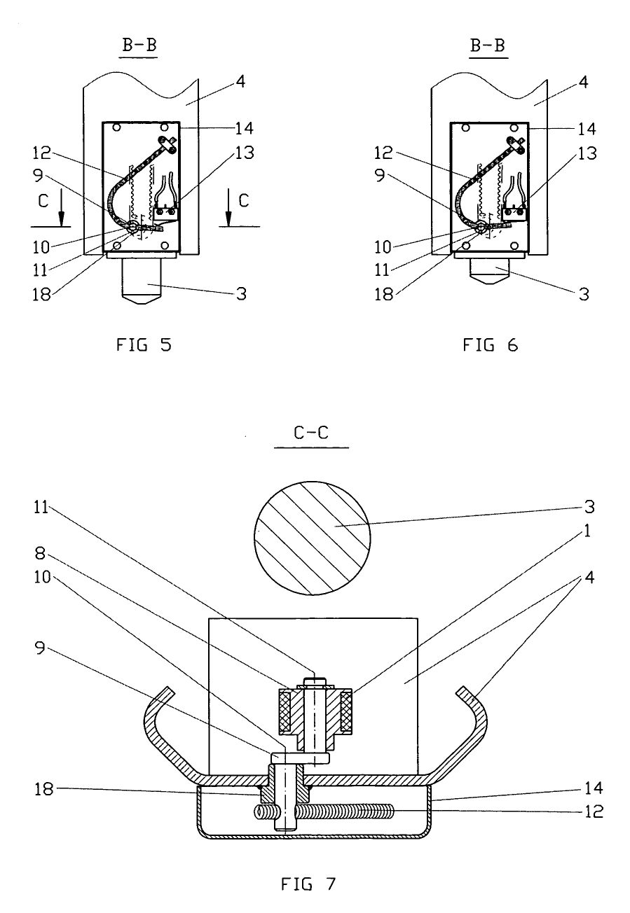

As an example FIG. 1, FIG. 2, FIG. 3, FIG. 4, FIG. 5, FIG. 6, FIG. 7 the torch lift mechanism is implemented with the gear belt 1 drive and stepper motor 2, which is suitable to be used on oxy-fuel and plasma cutting machines as well as cutting different materials on laser and water cutting, to initial height sensing and torch 3 positioning in a predetermined height above the workpiece. The stepper motor 2 is attached with four bolts 5 to the torch lifter body 4, which is made of bent sheet of steel. On the axle 6 an upper drawing pulley 7 is pressed. The lower pulley 8 can rotate freely, attached to the switch lever 9, witch in turn is attached to the torch lifter body 4 with joint 10, so that the the axle 11 of the lower pulley 8 and the axle 10 of the joint between torch lifter body 4 and switch lever 9, form parallel lines in a room. The stretch, created by the gear belt 1, can cause small shift of the switch lever 9, round the axle 10. To hold the gear belt 1 tense the spring 12 is used. The starkness of the spring 12 must be chosen so that the torque of the stepper motor 2 would be enough to shift the switch lever 9 so much as to enable the switch 13. The spring 12 between the switch lever 9 and switch 13 is needed to avoid the rupture of switch 13 under of excessive force. A dust cover 14 protects the switch 13 and spring 12 from the dust. The gear belt is attached to the torch holder 16 with screws 15. Rubber O-rings 17 are used to attach a torch 3, to the torch holder 16. A switch lever axle-box 18 has been welded to the torch lifter body 4. The two clamps 19 restrict the torch 3 to vertically shift in the relation to the torch holder 16. Four wheel holders 21 22 are attached to the torch holder 16 with screw nuts 20. Two of them are eccentric 21 to regulate the backlash between the torch lifter body 4 and wheel 23. The wheel 23 has been pressed backlachfree to the wheelholders 21 22 and in order to prevent the wheel from shifting, the end of the wheelholder is riveted 24. There is a horizontal collision switch 25 attached to the torch holder 16.

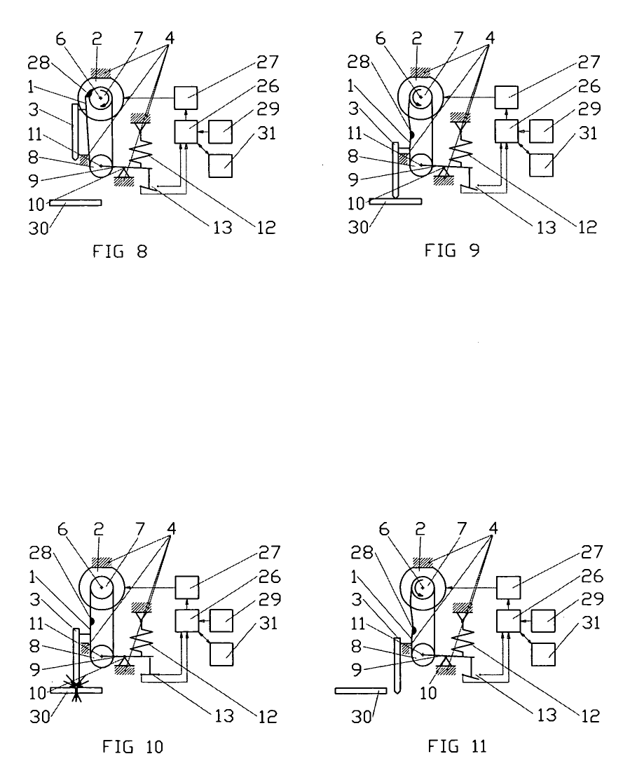

The work principle of the invention is as follows. When the device is switched on, the control system 26 gives a command to move torch holder 16 with torch 3 up. As a stepper motor driver 27 is in this circuit as an amplifier. The torch holder 16 alongside with the torch 3 moves up as long as the rubber O-ring 28, which is attached to the belt 1, stays between the belt 1 and the drawing pulley 7 FIG. 8. As a result of that, the lower freely rotating pulley 8 moves a little up, the switch lever 9 rotates little bit and the end of the spring 12 enables the switch 13 FIG. 6. A control system 26 responsive to the enablement of the switch 13 stops the stepper motor 2.

At the start of the cutting, the control system 26 gets a command from CNC controller 29. The torch holder 16 with the torch 3 moves down as long as the torch tip touches the workpiece 30. Now the control system 26 utilizes a circuit ground signal as the tip of the torch 3 comes in contact with the workpiece to stop and reverse the torch holder 16 with torch 3. If the ohmic sensor is not employed, for example while cutting painted plate, then the freely rotating pulley 8 moves a little up, the switch lever 9 rotates little bit and the end of the spring 12 enables the switch 13 FIG. 6 FIG. 9. A control system 26 responsive to the enabling of the switch 13 stops the stepper motor 2 and reverses it to raise the torch 3 to the predetermined pierce height.

Now the cutting process begins and the control system 26 starts to make torch height adjustments, for example during plasma cutting, according to the plasma arc voltage received from the plasma power supply 31. During that process the position of the switch 13 stays unchanged FIG. 5, and the switch 13 does not participate in the work of the device FIG. 10. If during cutting vertical collision happens, then a control system 26 responsive to the enablement of the switch 13 reverses the stepper motor 2 to raise the torch 3 to pierce height.

If the cutting starts and it happens that there is no material to cut or the material is too far FIG. 11, then the torch holder 16 touches the torch lifter body 4 and the process described above begins again where the torch 3 touches the workpiece 30.

The invention described above gives three functions to the switch 13:

initial height sensing FIG. 9;

upper limit FIG. 8;

lower limit FIG. 11.

It is also important to stop the cutting on horizontally oriented torch collisions with obstacles to avoid the damage of the torch 3 and to other parts of the cutting machine. The torch 3 is attached to the torch holder 16 with two rubber O-rings 17. In case of horizontally collision the torch will be displaced in comparison on to the torch holder 16 and enables the switch 25. The switch 25 passes the information on to the control system 26 witch gives the stop command to the CNC controller 29.

As the torch lifter body 4 and the torch holder 16 have been made from sheet-metal and after bending they are precise enough to ensure baclaschfree linear movements, then it is easy to produce the device in large numbers.

What is claimed is:

1. A torch height control apparatus for positioning the tip of a cutting torch with respect to a workpiece, said apparatus, comprising:
a linear positioning mechanism, said as torch lifter including vertical torch transport mechanism with synchronous belt drive, altering wheelbase of the wheel axis and the solid body, attached to the synchronous belt, operable to move the torch between upper and lower limit; and
control circuit means responsive to the switch signal for operating the torch lifter to move the torch to the predetermined non-contact position.

2. The mechanism as set forth in claim 1 wherein the mechanical resistance as cause torch tip contact with workpiece resulting from vertical downward movement, cause movement at least one wheel axle, used as information to control circuit to reverse the motor and raise the torch to predetermined non-contact position.

3. The mechanism as set forth in claim 1 wherein the mechanical resist as cause torch holder contact with torch lifter body resulting from vertical downward movement, cause movement at least one wheel axle, information about used as lower limit switch.

4. The mechanism as set forth in claim 1 wherein the belt stretching as cause a solid body, has been attached to the synchronous belt, witch moving between the belt and pulley, cause movement at least one wheel axle, information about used as upper limit switch.
